(19) United States
(12) Patent Application Publication
(10) Pub. No.: US 2003/0130416 A1
(43) Pub. Date: Jul. 10, 2003

(54) Method for producing binding agents for lacquer and their use in coating agents

(76) Inventors: Carmen Flosbach, Wuppertal (DE); Patrick Glockner, Haltern (DE); Peter Klostermann, Wuppertal (DE); Volker Paschmann, Essen (DE); Helmut Ritter, Wuppertal (DE)

Correspondence Address: Steven C Benjamin, E I du Pont de Nemours & Company, Legal Patents, Wilmington, DE, 19898, US

(21) Appl. No.: 10/169,675

(22) PCT Filed: Dec. 13, 2000
(86) PCT No.: PCT/EP00/12648

(30) Foreign Application Priority Data
Dec. 29, 1999 (DE) 199 63 586.2

(51) Int. Cl. C08K 3/00

(52) U.S. Cl. 524/801

(57) ABSTRACT

Process for the preparation of lacquer binders by the free-radical homo- or co-polymerisation of water-insoluble ethylenically unsaturated monomers, optionally together with water-soluble monomers, in which the homo- or co-polymerisation is carried out in an aqueous medium in the presence of conventional polymerisation initiators to a number-average molecular weight of from 1000 to 1,000,000, wherein either the polymerisation is carried out in the presence of cyclodextrin or cyclodextrin derivatives, and/or at least the water-insoluble monomers are used in the form of complexes with cyclodextrin and/or cyclodextrin derivatives.

The invention relates to the preparation of polyacrylate-based lacquer binders, especially for the preparation of powdered binders, by free-radical polymerisation, to the use of the binders in coating compositions, and to coating compositions containing them.

In the preparation of lacquer binders, the free-radical polymerisation of monomers in aqueous solutions is a conventional technical process for preparing polymeric compounds without using organic solvents.

In the case of emulsion polymerisation, difficulties can arise when water-soluble monomers are polymerised with water-insoluble monomers. In the case of copolymerisation, there is the difficulty in particular of obtaining pure copolymers, because the different monomers either do not copolymerise with one another or their polarities are too different.

According to DE-A-195 33 269, the polymerisation of water-insoluble monomers takes place either by polymerising them in the form of complexes with cyclodextrins or cyclodextrin derivatives, or by polymerising the monomers in the presence of such cyclodextrins. The resulting polymers are either in the form of inclusion compounds, from which they must be isolated, or they precipitate from the aqueous reaction solution.

There result hydrophobically modified polymers which can be used, for example, as thickeners.

The use of cyclodextrin derivatives in the polymerisation of, especially, water-insoluble monomers is also described in EP-A-0 710 675 and in EP-A-0 896 027. The resulting polymers of low water solubility can be used, for example, as viscosity regulators or as an additive for improving water resistance in corresponding coating compositions.

The mentioned literature does not provide for the use of the resulting polymers directly as binders for formulating lacquers. The described cases permit their use only as an additive for improving particular properties or as an agent for regulating the viscosity of coating formulations.

In DE-A-44 34 584, cyclodextrin derivatives are used in coating compositions as additives for preventing faults in the lacquer film properties. Inclusion compounds are formed thereby, which render ineffective impurities, which can cause superficial faults in particular. Cyclodextrin derivatives causing such inclusion compounds are a direct constituent of the coating agent compositions and are not used as an auxiliary substance for the preparation of lacquer binders.

The object of the present invention is to find a process for the preparation of binders based on polymers, especially based on polyacrylates, that allows lacquer binders, especially powder coating binders, to be prepared in a simple manner, which binders can be used directly in lacquer compositions and achieve a good finishing lacquer condition and good flow.

It has been found that that object can be achieved by a process for the preparation of lacquer binders by the free-radical polymerisation, in an aqueous environment, of water-insoluble, unfunctionalised and/or functionalised monomers which are ethylenically unsaturated, optionally together with water-soluble functionalised and/or unfunctionalised monomers, in the form of complexes with cyclodextrin and/or cyclodextrin derivatives or in the presence of cyclodextrin and/or cyclodextrin derivatives. For the sake of simplicity, the homo- and co-polymers are hereinafter referred to also as “polyacrylates”.

Accordingly, the invention provides a process for the preparation of lacquer binders by the free-radical homo- or co-polymerisation of water-insoluble ethylenically unsaturated monomers, optionally together with water-soluble monomers, which process is characterised in that the homo- or co-polymerisation is carried out in an aqueous medium in the presence of conventional polymerisation initiators to a number-average molecular weight of from 1000 to 1,000,000, wherein either the polymerisation is carried out in the presence of cyclodextrin or cyclodextrin derivatives, and/or at least the water-insoluble monomers are used in the form of complexes with cyclodextrin and/or cyclodextrin derivatives.

The monomers used may be functionalised or free of functional groups. After separation, the resulting polymers can be used directly as lacquer binders. The resulting polymer dispersions can also be used directly as binders.

Once polymerisation has taken place, the polymers can be obtained in the form of inclusion compounds with the cyclodextrin compounds, in the form of powdered polymers, or in the form of a liquid organic phase.

In the case of the inclusion compounds that are formed, they can be used directly, without additional treatment, as an aqueous binder dispersion for lacquer compositions. With suitable selection of the monomers, especially by the use of monomers of complementary functionality, they can also be used in the form of a powder slurry.

In the case of the resulting powdered polymers and the liquid organic phase of the polymers, they can be used directly as a powder binder or as a liquid binder once they have been separated in a simple manner from the reaction solution. After isolation of the resulting polymer, the reaction solution that remains can be used again for the polymerisation of further monomers that can be used according to the invention. It is thus possible for the cyclodextrin or cyclodextrin derivative that is used to be employed repeatedly for the synthesis in the form of a continuous, semi-continuous or batchwise process, and hence for a reduction in costs to be achieved.

The preparation of powdered polyacrylate binders preferably takes place in the manner described above. The powders preferably have a glass transition temperature T_{g}≧25° C.

By means of the process according to the invention using cyclodextrin or a cyclodextrin derivative it is, surprisingly, possible to obtain homogeneous homo- and/or co-polymers of the desired composition having a specific number-average molecular weight Mn in a wide range from 1000 to 1,000,000, preferably from 1000 to 100,000, particularly preferably from 1000 to 10,000, which polymers can be used directly as lacquer binders.

The homo- and/or co-polymers obtained by the process according to the invention can be used especially for the formulation of powder coating compositions using the polymers obtained according to the invention having a number-average molecular weight Mn in the range from 1000 to 10⁵, preferably from 1000 to 10⁴.

According to the invention, the water-insoluble monomers are ethylenically unsaturated monomers that are water-soluble at most up to 20 g/l at 20° C. Examples of such compounds are styrene, α-methylstyrene, C₂-C₄₀-alkyl esters of acrylic acid or C₁-C₄₀-alkyl esters of methacrylic acid, such as methyl methacrylate; ethyl acrylate, propyl methacrylate, isopropyl acrylate, n-butyl methacrylate, isobutyl acrylate, tert-butyl methacrylate, pentyl methacrylate, n-hexyl methacrylate, n-heptyl methacrylate, n-octyl acrylate, 2-ethylhexyl acrylate, decyl methacrylate, lauryl methacrylate, palmityl methacrylate, phenoxyethyl methacrylate, phenyl methacrylate, cyclohexyl methacrylate, tert-butylcyclohexyl acrylate, butylcyclohexyl methacrylate, trimethylcyclohexyl methacrylate.

Further examples of monomers of that group are glycidyl-functionalised monomers, such as, for example, glycidyl (meth)acrylate, 1,2-epoxybutyl (meth)acrylate or 2,3-epoxycyclopentyl (meth)acrylate. Further copolymerisable glycidyl monomers are, for example, (meth)allyl glycidyl ether or 3,4-epoxy-1-vinylcyclohexane.

Hydroxyalkyl esters of α,β-unsaturated carboxylic acids such as acrylic acid and/or methacrylic acid having a primary OH group and a C₅-C₁₈-hydroxyalkyl radical also belong to that group, such as, for example, hydroxyhexyl acrylate, hydroxyoctyl acrylate and the corresponding methacrylates, and reaction products of hydroxyethyl (meth)acrylate with caprolactone, as well as monomers having secondary OH functions, such as adducts of glycidyl (meth)acrylate and saturated short-chain acids having C₁-C₃-alkyl radicals, for example acetic acid or propionic acid, reaction products of glycidyl (meth)acrylate with saturated branched or unbranched fatty acids having C₄-C₂₀-alkyl radicals, for example butanoic acid, lauric acid, stearic acid, and also adducts of glycidyl esters of highly branched monocarboxylic acids (glycidyl ester of versatic acid is obtainable under the trade name Cardura E) with unsaturated COOH-functional compounds such as, for example, acrylic or methacrylic acid, maleic acid, adducts of Cardura E with unsaturated anhydrides such as, for example, maleic anhydride. The reaction of the acrylic acid or methacrylic acid with the glycidyl ester of a carboxylic acid having a tertiary α-carbon can take place before, during or after the polymerisation reaction.

Further examples of the mentioned monomers are N-alkyl-substituted acrylamides and methacrylamides, such as N-tert-butylacrylamide, N-octylacrylamide, N-hexadecylmethacrylamide, N-methacrylamidocaproic acid, N,N-dibutylacrylamide.

Other monomers that can be used are vinyl alkyl ethers having from 1 to 40 carbon atoms in the alkyl radical, for example methyl vinyl ether, n-propyl vinyl ether, isobutyl vinyl ether, 2-ethylhexyl vinyl ether, octadecyl vinyl ether, 2-(diethylamino)ethyl vinyl ether as well as the corresponding allyl ethers such as allyl ethyl ether, allyl n-propyl ether and allyl 2-ethylhexyl ether. Also suitable are esters of maleic acid and fumaric acid that are derived from monohydric alcohols having from 1 to 22 carbon atoms, for example maleic acid mono-n-butyl ester, maleic acid monodecyl ester, maleic acid didodecyl ester, as well as vinyl esters of saturated C₃- to C₄₀-carboxylic acids, such as vinyl propionate, vinyl 2-ethylhexanoate, vinyl stearate and vinyl laurate. Other monomers are methacrylonitrile, vinylidene chloride, isoprene.

For the preparation of the complexes or in the polymerisation, the above-mentioned water-insoluble monomers can be used alone or in a mixture. Compounds that preferably come into consideration are C₂- to C₃₀-alkyl esters of acrylic acid, C₂- to C₃₀-alkyl esters of methacrylic acid, C₁- to C₂₀-alkyl vinyl ethers, styrene, α-methylstyrene. Particularly preferred monomers are methyl methacrylate, butyl acrylate, lauryl acrylate, stearyl acrylate, alicyclically substituted acrylates and methacrylates, styrene, α-methylstyrene, glycidyl (meth)acrylate, methyl vinyl ether, ethyl vinyl ether, octadecyl vinyl ether or mixtures thereof.

Suitable water-soluble monomers that can be used according to the invention are, for example, monoethylenically unsaturated C₃-C₅-carboxylic acids, their monoesters with C₂-C₄-diols, their esters with oligomeric ethylene oxide units, which consist of at least two ethylene oxide units, their amides and esters with amino alcohols of the formula

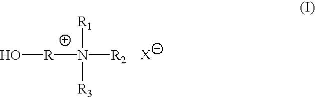

in which R═C₂- to C₅-alkylene, R₁, R₂, R₃═CH₃, C₂H₅, C₃H₇, and Xθ represents an anion. Also suitable are amides derived from amines of the formula

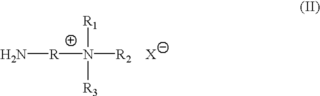

The substituents in formula II and Xθ have the same meaning as in formula I.

Such compounds are, for example, acrylic acid and methacrylic acid, itaconic acid, maleic acid, hydroxyethyl methacrylate, butanediol monoacrylate, acrylamide, crotonic acid amide, dimethylaminoethyl acrylate, dimethylaminoethyl methacrylate, dimethylaminopropyl methacrylate, N-isobutyl methacrylate, dimethylaminoneopentyl methacrylate. Phenoxyethyl acrylate, for example, also belongs to that group. The basic acrylates and methacrylates or basic amides derived from the compounds of formula II are used in the form of the salts with strong mineral acids, sulfonic acids or carboxylic acids or in quaternised form. The anion Xθ for the compounds of formula I is the acid radical of the mineral acids or of the carboxylic acids, or methosulfate, ethosulfate or halide of a quaternising agent.

Further water-soluble monomers that can be used are N-vinylpyrrolidone, N-arylamidopropanesulfonic acid, vinylphosphonic acid and/or alkali or ammonium salts of vinylsulfonic acid. Such monomers can likewise be used in the polymerisation either in non-neutralised form or in a partly neutralised or up to 100% neutralised form. Suitable water-soluble monomers are also diallylammonium compounds, diethyldiallylammonium chloride, N-vinylimidazolium compounds, such as salts or quaternisation products of N-vinylimidazole and 1-vinyl-2-methylimidazole, and N-vinylimidazolines, such as N-vinylimidazoline, 1-vinyl-2-methylimidazoline, which are likewise used in quaternised form or in the form of a salt in the polymerisation.

Water-soluble monomers that can preferably be used are monoethylenically unsaturated C₃-C₅-carboxylic acids, vinylsulfonic acid, acrylamidomethylpropanesulfonic acid, vinylphosphonic acid, N-vinylformamide, dimethylaminoethyl (meth)acrylate, dimethylpropyl(meth)acrylamide, hydroxyethyl (meth)acrylate, hydroxypropyl (meth)acrylate, alkali or ammonium salts of the mentioned acid-group-containing monomers, or mixtures of the monomers with one another. The use of acrylic acid or mixtures of acrylic acid and maleic acid or their alkali salts is of particular economic importance in the preparation of hydrophobically modified water-soluble copolymers.

All the mentioned monomers can each be subjected to free-radical polymerisation alone or in a mixture with one another.

By the use of complementary monomers in particular, it is also possible to obtain reactive powder slurries once polymerisation has taken place. Complementary monomers are generally monomers which are able to enter into an addition or condensation reaction with one another via their functional groups, for example glycidyl methacrylate, butanediol monoacrylate, (meth)acrylic acid.

In addition to the mentioned monomers according to the invention, small amounts of further monomers may be used, for example monomers having at least 2 polymerisable olefinically unsaturated double bonds, for example hexanediol di(meth)acrylate, ethylene glycol di(meth)acrylate, hexamethylenebis(meth)acrylamide, divinylbenzene.

Such monomers can be used alone or in a mixture in an amount of from 0 to 5 wt. %, based on total monomers. As cyclodextrins there may be used alpha-, beta-, gamma- and delta-cyclodextrins. They are known and consist of from 6 to 9 D-glycose units, which are bonded together via an alpha-1,4-glycoside bond. Cyclodextrin derivatives are compounds which are, for example, reaction products of cyclodextrins with reactive compounds, for example reaction products of cyclodextrins with alkene oxides such as, for example, ethylene oxide, propylene oxide, butylene oxide or styrene oxide, reaction products of cyclodextrins with alkylating agents, for example C1 to C22 alkyl halides, for example methyl chloride, ethyl chloride, butyl chloride, lauryl chloride, stearyl chloride. It is also possible to use cyclodextrin derivatives based on the reaction of cyclodextrin with chloroacetic acid and on enzymatic linkage with maltose oligomers, for example dimethyl-beta-cyclodextrin, sulfonatopropylhydroxypropyl-beta-cyclodextrin.

There are preferably used alpha-, beta-, gamma-cyclodextrin, 2,6-dimethyl-beta-cyclodextrin and/or methylated beta-cyclodextrin having a degree of methylation of 1.8.

According to the invention, the polymerisation of the mentioned monomers can take place in the presence of the cyclodextrins or of the cyclodextrin derivatives or by the previous formation of a complex of the monomers with the cyclodextrin or the cyclodextrin derivatives.

The polymerisation of the monomers that can be used according to the invention in the presence of the cyclodextrins and/or cyclodextrin derivatives can be so carried out that up to 5 mol of cyclodextrins and/or cyclodextrin derivatives are used per mol of the mentioned monomers used according to the invention. Where complexes are used, the monomers mentioned according to the invention are used with the cyclodextrins and/or cyclodextrin structures in a molar ratio of from 1:10 to 2:1.

The complexes can be prepared according to conventional methods of the prior art. For example, the cyclodextrin can be dissolved in a solvent with at least one monomer, a crystalline complex resulting after removal of the solvent.

Furthermore, there may be used for the components solvents in which only one component in each case is soluble and the others are incorporated by mechanical/thermal means. It is also possible to work entirely without solvents. The formation of the complexes can be carried out at normal pressure, under reduced pressure or alternatively under elevated pressure.

Formation of the complex is preferably carried out by placing the cyclodextrin or cyclodextrin derivative in water and incorporating the monomer used according to the invention into that aqueous solution or emulsion. The molar ratio of monomer and cyclodextrin is preferably from 1:5 to 1:1.

The polymerisation takes place in a known manner by solution or precipitation polymerisation in an aqueous medium, especially in water. “Aqueous medium” can be understood as meaning also mixtures of water with water-miscible organic liquids, such as, for example, glycols, acetic acid esters of glycol, alcohols, acetone, tetrahydrofuran, methylpyrrolidone or mixtures of the mentioned solvents. The polymerisation is preferably carried out in water.

The polymerisation can be carried out, for example, with the exclusion of oxygen, optionally under pressure, for example at temperatures of from 10 to 200° C., preferably from 20 to 140° C., discontinuously or continuously.

As polymerisation initiators there may be used the conventional initiators, for example inorganic and organic peroxides, hydroperoxides, percarbonates, azo compounds.

The known redox catalysts may also be added, for example salts of transition metals, sulfur compounds having a reducing action, or phosphorus compounds having a reducing action.

The regulators conventional in polymerisations may also be added, for example in amounts of from 0 to 20 wt. %, based on the monomers to be polymerised, for example cysteine, mercapto or thiol compounds carrying a homolytically cleavable S—H grouping, for example N-acetyl-L-cysteine, 2-mercaptoethanol, mercapto alcohols, C₁-C₂₀-alkylmercaptans. Salts of hydrazine, aldehydes, formic acid, ammonium formate, hydroxylammonium sulfate may also be used as regulators.

According to the invention, the monomers can be placed in an aqueous solution of cyclodextrins and/or cyclodextrin derivatives and polymerised in the presence of polymerisation initiators and, optionally, polymerisation regulators.

Moreover, it is also possible uniformly to add some or all of the monomers continuously and/or semi-continuously to the aqueous solution of cyclodextrins and/or cyclodextrin derivatives in the reaction vessel during the polymerisation, optionally together with the initiators and, optionally, further additives, and to polymerise the mixture.

For example, the process can be so carried out that the cyclodextrin is first dissolved in water, and the monomers that can be used according to the invention are then dispersed in that solution. The dispersion may optionally take place in an ultrasonic bath. The dispersion optionally continues until a clear phase is obtained. The initiator is then added, and polymerisation begins. The polymerisation optionally takes place in the presence of so-called polymerisation regulators. According to the invention, the homo- and/or co-polymers formed can precipitate from the aqueous reaction solution, after cooling of the reaction solution, in the form of a powder or in the form of an organic phase. Moreover, they may also be obtained in the form of a stable aqueous dispersion.

In the case of powdered polymers, they are filtered off and washed, yielding a polymer that is available directly as a powdered binder for lacquer compositions.

The reaction solution that remains after isolation of the powdered polymers or of the organic phase of the polymers contains almost all of the cyclodextrin or cyclodextrin derivative used and can therefore be used for further syntheses of that type, by dispersing corresponding monomers according to the invention in the reaction solution again and starting the polymerisation.

The process according to the invention makes it possible to prepare, from the mentioned monomers, homo- and co-polymers, especially homogeneous copolymers, having a wide molecular weight regulation, within the scope of a simple and elegant process, without the temperature load and complicated procedure present in the case of conventional polymerisation methods.

In particular, the possibility of separating off the resulting polymer and re-using the remaining reaction solution for a further synthesis allows the process to be carried out in a simple and inexpensive manner.

With the process according to the invention it is possible to obtain the resulting polymers directly as lacquer binders, in a continuous or semi-continuous manner, either in the form of a powder, in the form of an organic phase, or in the form of an aqueous dispersion, without the previous working steps and energy-intensive working-up steps of conventional polymerisation methods being required, such as, for example, distillation, distillate destruction, confectioning in corresponding cooling devices, etc..

The resulting binders can be processed to lacquer compositions without particular processing steps having to be taken. The use of the powdered polymers as binders in powder coating compositions is preferably possible. The resulting lacquer compositions permit good wettability to be obtained, with good finishing lacquer condition and flow.

Accordingly, the invention relates also to the use of the homo- and co-polymers prepared according to the invention as lacquer binders in coating compositions. It relates also to the coating compositions as such. For the preparation of the coating compositions, the binders produced according to the invention can be formulated in a known manner. For example, it is possible to add crosslinkers which, in the conventional manner, carry functional groups that are complementary to functional groups optionally contained in the binders. Components conventional in coating compositions, such as inorganic or organic pigments, fillers and/or additives, such as flow agents, degassing agents and/or accelerators, can be incorporated.

### EXAMPLE 1

### Preparation of a Complex with Cyclodextrin and Homopolymerisation

### Complex I

266.3 g (200.0 mmol) of partially methylated β-cyclodextrin (me-β-CD) were dissolved in 642 g of water, and 32.0 g (153.6 mmol) of isobornyl acrylate were added. The thoroughly shaken, yellowish O/W suspension was left in an ultrasonic bath for 20 minutes, whereupon a clear yellowish solution of the complexed monomer formed as a 1:1 complex.

The prepared solution can be used directly for polymerisation; the yield is accordingly quantitative.

### Complexes II-X

Analogously to the preparation of complex I, complexes of monomers indicated in Table 1 with me-β-CD in a molar ratio of 1:1 were prepared.

TABLE 1

| Complex | Monomer |
|---|---|
| II | Butyl acrylate |
| III | Butyl methacrylate |
| IV | Cyclohexyl methacrylate |
| V | Glycidyl methacrylate |
| VI | Hydroxyethyl acrylate |
| VII | Hydroxyethyl methacrylate |
| VIII | Isobornyl methacrylate |
| IX | Methyl methacrylate |
| X | Styrene |

Homopolymerisation of Complex I

0.2 g of potassium peroxodisulfate (K₂S₂O₈) and 0.1 g of sodium hydrogen sulfite (NaH—SO₃) were added to 100 g of the aqueous solution of complex I of isobornyl acrylate and me-β-CD. The solution was polymerised at room temperature, with the exclusion of oxygen. Initial clouding occurred after approximately 3 minutes and is attributable to the precipitated, water-insoluble homopolymer. After 12 hours, the resulting polymer was separated from the aqueous solution and dried. The polymer was obtained in a yield of 93%, free of me-β-CD.

### EXAMPLE 2 to 10

### Homopolymerisation of Complexes II to X

Homopolymers of complexes II to X were prepared analogously to Example 1. The yields are given in Table 2.

TABLE 2

| Example | Complex | Yield [%] |
|---|---|---|
| 2 | II | 89 |
| 3 | III | 94 |
| 4 | IV | 91 |
| 5 | V | 90 |
| 6 | VI | 84 |
| 7 | VII | 79 |
| 8 | VIII | 92 |
| 9 | IX | 90 |
| 10 | X | 93 |

### EXAMPLE 11

### Copolymerisation of Complex I with Complex II (1:1 Molar)

5.88 9 of complex I solution and 5.80 g of complex II solution were heated to 85° C., with stirring and with the exclusion of oxygen, and 0.025 g of 2,2′-azobis(2-amidino-propane) dihydrochloride (AAP)/was added. After 4 hours, the polymerisation was terminated by cooling and addition of 15 ml of water. The solid already precipitated during the reaction was separated from the mother liquor, taken up in 2 ml of THF and precipitated from 50 ml of water, yielding a colourless polymer. The yield was 88%.

### EXAMPLES 12 to 15

### Copolymerisation of the Other Complexes

Copolymers of the complexes indicated in the Table below were prepared analogously to Example 11. The yields are indicated in Table 3.

TABLE 3

| Example | Complex | Yield [%] |
|---|---|---|
| 12 | II/X | 89 |
| 13 | III/V | 94 |
| 14 | III/X | 91 |
| 15 | IX/X | 90 |

### EXAMPLE 16

### Copolymerisation of Water-Soluble Monomers with CD-Complexed Monomers

N-Isopropylacrylamide to complex X : molar ratio 9:1

0.1 9 of styrene was added to 1.0 g of N-isopropylacrylamide and 1.31 g of me-β-CD, dissolved in 30 ml of water. After complexing by ultrasonic treatment, rinsing with nitrogen was carried out, and 0.13 g of potassium peroxodisulfate and 0.055 g of sodium hydrogen sulfite were added in a nitrogen countercurrent; polymerisation was then carried out for 10 hours, with stirring. The already cloudy batch was heated to approximately 50° C., and the precipitated polymer was filtered off while warm and washed thoroughly with hot water.

### EXAMPLE 17 to 22

### Copolymerisation of Water-Soluble Monomer with Further Complexes

Copolymers of the complexes shown in Table 4 with N-isopropylacrylamide were prepared analogously to Example 16. The yields are indicated in that Table.

Table 4

Yield [%]

| Example | Complex | 9:1 | 4:1 | 2:1 | 1:1 |
|---|---|---|---|---|---|
| 18 | X | 87 | 79 | 80 | 84 |
| 19 | I | 88 | 85 | | |
| 20 | VIII | 79 | 82 | | |
| 21 | III | 67 | 73 | | |
| 22 | IV | 73 | 71 | | |

### EXAMPLE 23

### Influence of Regulators on the Degree of Polymerisation of the Complexes

12.8 g of me-β-CD were dissolved in 30 ml of water, and 1.0 g of styrene was added. Shaking and ultrasonic treatment for 15 minutes yielded a clear yellowish solution of complex X. 0.31 g of potassium peroxodisulfate and 0.12 g of sodium hydrogen sulfite, as well as 0.20 g of N-acetyl-L-cysteine, were added to the solution. The batch was stirred for 16.5 hours with the exclusion of oxygen. The precipitated polymer was then filtered off with suction, washed with water and dried.

In the same manner, a reaction without N-acetyl-L-cysteine was carried out. The mean molecular weight can be drastically affected by the use of regulator molecules.

Mean Molecular Weights of the Prepared Polymers Xb (With Regulator), Xc (Without regulator)

TABLE 5

| | M_{w} | Mₙ | |
|---|---|---|---|
| | g · mol⁻¹ | g · mol⁻¹ | D |
| Xb | 11,600 | 1900 | 6.3 |
| Xc | 158,000 | 3300 | 48.2 |

### EXAMPLE 24 to 30

Polymers of-the complexes shown in Table 6 were prepared analogously to Example 23.

TABLE 6

| Example | Complex | Monomer |
|---|---|---|
| 24 | II | Butyl acrylate |
| 25 | III | Butyl methacrylate |
| 26 | IV | Cyclohexyl |
| | | methacrylate |
| 27 | V | Glycidyl |
| | | methacrylate |
| 28 | VI | Hydroxyethyl |
| | | acrylate |
| 29 | VII | Hydroxyethyl |
| | | methacrylate |
| 30 | IX | Methyl methacrylate |

In addition to the use of N-acetyl-L-cysteine as regulator, all other mercapto compounds carrying a homolytically cleavable S—H grouping are suitable. They are, for example, N-acetyl-L-cysteine methyl ester, cysteine, 2-mercaptoethanol, dodecylmercaptan.

Synthesis of a Polymer Using me-β-CD in the Cyclic Process

364.1 g of me-β-CD were dissolved in 922.0 g of water, and 10.64 g of glycidyl methacrylate, 3.37 g of styrene, 7.03 g of butyl methacrylate and 8.95 g of methyl methacrylate were added. The mixture was shaken and the resulting dispersion was treated with ultrasound. After approximately 20 minutes of ultrasound, a yellowish, clear solution was obtained. The solution was heated to 80° C., with stirring and with the exclusion of oxygen; 5.34 g of potassium peroxodisulfate were added, and the reaction was carried out at from 80 to 85° C. for 6 hours. Cooling was then carried out, and the polymer precipitated during the reaction was separated from the mother liquor. The polymer was twice suspended in 400 ml of water each time and filtered off again. The first wash water had a solids content of approximately 7%. It was mainly me-β-CD. The second wash water was free of me-β-CD to the greatest possible extent; its solids content was below 1%. The resulting colourless polymer was freed of water. The yield was 85%.

The monomers listed in Table 7 were added to the resulting mother liquor (preparation 2). The further procedure corresponded to the first reaction procedure. A total of five preparations was carried out using the mother liquor from the preceding reaction in each case. The amount of mother liquor falls with each reaction preparation, because it is not possible to free the polymer from the solvent completely. In order to ensure a sufficiently large preparation amount, 45 g of me-β-CD and 105 g of water were therefore added to the fourth preparation.

TABLE 7

| | Weighed | Weighed | Weighed | Weighed |
|---|---|---|---|---|
| | portion | portion | portion | portion |
| | Preparation 2 | Preparation 3 | Preparation 4¹⁾ | Preparation 5 |
| Glycidyl | 9.40 g | 8.40 g | 9.16 g | 7.59 g |
| methacrylate | | | | |
| Styrene | 2.98 g | 2.65 g | 2.90 g | 2.41 g |
| Butyl | 6.21 g | 5.54 g | 6.05 g | 5.01 g |
| methacrylate | | | | |
| Methyl | 7.90 g | 7.05 g | 7.70 g | 6.38 g |
| methacrylate | | | | |
| K₂S₂O₈ | 4.72 g | 4.21 g | 4.59 g | 3.81 g |
| Mother | 1286 g | 1147 g | 1253 g¹⁾ | 1038 g |
| liquor | | | | |
| Yield | 83% | 80% | 85% | 89% |

¹⁾45 g of me-β-CD and 105 g of water were added to the 5 mother liquor.

1. Process for the preparation of lacquer binders by the free-radical homo- or co-polymerisation of water-insoluble ethylenically unsaturated monomers, optionally together with water-soluble monomers, characterised in that the homo- or co-polymerisation is carried out in an aqueous medium in the presence of conventional polymerisation initiators to a number-average molecular weight of from 1000 to 1,000,000, wherein either the polymerisation is carried out in the presence of cyclodextrin or cyclodextrin derivatives, and/or at least the water-insoluble monomers are used in the form of complexes with cyclodextrin and/or cyclodextrin derivatives.

2. Process according to claim 1, characterised in that the homo- and/or co-polymers are obtained in the form of powders or aqueous powder slurries.

3. Process according to claim 1 or 2, characterised in that the resulting homo- or co-polymers are separated off and the aqueous phase that remains is fed back into the process again.

4. Process according to any one of claims 1 to 3, characterised in that the homo- or co-polymers that are prepared are incorporated directly into coating compositions as binders.

5. Use of the homo- or co-polymers prepared according to any one of claims 1 to 4 as binders for the preparation of coating compositions.

6. Use according to claim 5, characterised in that powder coatings are prepared.

7. Use of the homo- or co-polymers prepared according to any one of claims 1 to 4 as binders in coating compositions.

8. Coating compositions having a content of film-forming binders and, optionally, crosslinkers, pigments, fillers, and/or additives conventional in lacquers, characterised in that they contain as film-forming binders one or more homo- and co-polymers prepared according to the process of any one of claims 1 to 4.

9. Coating composition according to claim 8, characterised in that it is in the form of a powder coating.

10. Coating composition according to claim 7, characterised in that it is in the form of a powder slurry.
